(19) United States
(12) Patent Application Publication
(10) Pub. No.: US 2026/0086774 A1
(43) Pub. Date: Mar. 26, 2026

(54) ESTIMATION APPARATUS, DESIGN SUPPORT APPARATUS, ESTIMATION METHOD, DESIGN SUPPORT METHOD AND COMPUTER PROGRAM

(71) Applicant: NTT Inc., Tokyo (JP)

(72) Inventors: Takeshi KAKIZAKI, Musashino-shi (JP); Masanori NAKAMURA, Musashino-shi (JP); Fukutaro HAMAOKA, Musashino-shi (JP)

(73) Assignee: NTT Inc., Tokyo (JP)

(21) Appl. No.: 19/120,131

(22) PCT Filed: Oct. 17, 2022
(86) PCT No.: PCT/JP2022/038639

§ 371 Date: Apr. 10, 2025

(51) Int. Cl. G06F 8/30

(52) U.S. Cl. CPC G06F 8/30

(57) ABSTRACT

An estimation apparatus including a controller that reads information from a storage that stores a set of code and parameter used for communication and information indicating performance requested to achieve predetermined communication quality in communication using the code and parameter in association with each other, and estimates an SNR to be requested in an MLC (Multilevel Coding) using the code and parameter indicated by the inputted information.

### TECHNICAL FIELD

The present invention relates to an estimation apparatus, a design support apparatus, an estimation method, a design support method and a computer program.

### BACKGROUND ART

In recent years, due to an increase in traffic, large-capacity of mission-critical optical transmission is requested. As part of that, in a forward error correction (FEC) in a DSP (Digital Signal Processor) used in the mission-critical optical transmission network, a technique for reducing computational complexity for various modulation multilevel degree has been studied. As one example of such a reduction of computational complexity, there has been proposed an MLC (Multilevel coding: see NPL 1) and a similar scheme (see NPL 2 to NPL 6). The MLC efficiently reduces SD-FEC (Soft-decision FEC) having high performance but large computational complexity.

In designing the MLC, it is necessary to design an error correction code corresponding to an SNR (Signal-to-Noise Ratio) of a signal. For this reason, performance has been conventionally estimated by simulating the designed MLC configuration.

### CITATION LIST

### Non Patent Literature

NPL 1: H. Imai and S. Hirakawa, “A new multilevel coding method using error-correcting codes,” in IEEE Transactions on Information Theory, vol. 23, no. 3, pp. 371-377, May 1977, doi: 10.1109/TIT.1977.1055718.
NPL 2: M. Barakatain, D. Lentner, G. Boecherer and F. R. Kschischang, “Performance-Complexity Tradeoffs of Concatenated FEC for Higher-Order Modulation,” in Journal of Lightwave Technology, vol. 38, no. 11, pp. 2944-2953, 1 Jun. 1, 2020, doi: 10.1109/JLT.2020.2983912.
NPL 3: Yohei Koganei, Tomofumi Oyama, Kiichi Sugitani, Hisao Nakashima, and Takeshi Hoshida, “Multilevel Coding With Spatially Coupled Repeat-Accumulate Codes for High-Order QAM Optical Transmission,” J. Lightwave Technol. 37, 486-492 (2019)
NPL 4: A. Bisplinghoff, S. Langenbach and T. Kupfer, “Low-Power, Phase-Slip Tolerant, Multilevel Coding for M-QAM,” in Journal of Lightwave Technology, vol. 35, no. 4, pp. 1006-1014, 15 Feb. 15, 2017, doi: 10.1109/JLT.2016.2625047.
NPL 5: Kakizaki, Takeshi, et al. “Low-complexity Channel Polarized Multilevel Coding for Modulation-format-independent Forward Error Correction.” 2021 European Conference on Optical Communication (ECOC). IEEE, 2021.
NPL 6: Kakizaki, Takeshi, et al. “Low-complexity Channel-polarized Multilevel Coding for Probabilistic Amplitude Shaping.” 2022 Optical Fiber Communications Conference and Exhibition (OFC). IEEE, 2022.

### SUMMARY OF INVENTION

### Technical Problem

However, in the conventional method of designing the error correction code having a performance estimation process by simulation, a load in execution of the simulation is large. That is, since it takes much time to perform the simulation, design efficiency is low.

In view of the foregoing circumstances, an object of the present invention is to provide a technique capable of estimating performance of encoding with smaller computational complexity.

### Solution to Problem

One aspect of the present invention is an estimation apparatus including a controller that reads information from a storage that stores a set of code and parameter used for communication and information indicating performance requested to achieve predetermined communication quality in communication using the code and parameter in association with each other, and estimates an SNR to be requested in an MLC using the code and parameter indicated by the inputted information.

One aspect of the present invention is a design support apparatus including an estimator that reads information from a storage that stores a set of code and parameter used for communication and information indicating performance requested to achieve predetermined communication quality in communication using the code and parameter in association with each other, and estimates an SNR to be requested in an MLC using the code and parameter indicated by the inputted information, and a design information judge that judges one or a plurality of sets of code and parameter to be applied to the MLC based on the information estimated by the estimator.

One aspect of the present invention is an estimation method including a control step of reading information from a storage that stores a set of code and parameter used for communication and information indicating performance requested to achieve predetermined communication quality in communication using the code and parameter in association with each other, and estimating an SNR to be requested in an MLC using the code and parameter indicated by the inputted information.

One aspect of the present invention is a design support method including an estimation step of reading information from a storage that stores a set of code and parameter used for communication and information indicating performance requested to achieve predetermined communication quality in communication using the code and parameter in association with each other, and estimating an SNR to be requested in an MLC using the code and parameter indicated by the inputted information, and a design information judgement step of judging one or a plurality of sets of code and parameter to be applied to the MLC based on the information estimated in the estimation step.

One aspect of the present invention is a computer program causing a computer to function as an estimation apparatus including a controller that reads information from a storage that stores a set of code and parameter used for communication and information indicating performance requested to achieve predetermined communication quality in communication using the code and parameter in association with each other, and estimates an SNR to be requested in an MLC using the code and parameter indicated by the inputted information.

One aspect of the present invention is a computer program causing a computer to function as a design support apparatus including an estimator that reads information from a storage that stores a set of code and parameter used for communication and information indicating performance requested to achieve predetermined communication quality in communication using the code and parameter in association with each other, and estimates an SNR to be requested in an MLC using the code and parameter indicated by the inputted information, and a design information judge that judges one or a plurality of sets of code and parameter to be applied to the MLC based on the information estimated by the estimator.

### Advantageous Effects of Invention

According to the present invention, it is possible to estimate the performance of encoding with smaller computational complexity.

### BRIEF DESCRIPTION OF DRAWINGS

FIG. 1 is a block diagram showing an outline of a functional configuration of an estimation apparatus 80 according to the present invention.

FIG. 2 is a diagram showing an outline of an estimation value of a request SNR.

FIG. 3 is a block diagram showing an outline of the functional configuration of a design support apparatus 70 according to the present invention.

FIG. 4 is a diagram showing a configuration example of a DSP configured in this way.

FIG. 5 is a block diagram showing a configuration example of a transmission apparatus.

FIG. 6 is a block diagram showing a configuration example of a reception apparatus.

### DESCRIPTION OF EMBODIMENTS

Hereinafter, one embodiment of the present invention will be described with reference to the drawings. Note that a superscript is described using \hat{ }, and a subscript is described using. For example, in the case of describing a character in which b is added as the superscript and c is added as the subscript to a character A, it is described as A\hat{ }b_c.

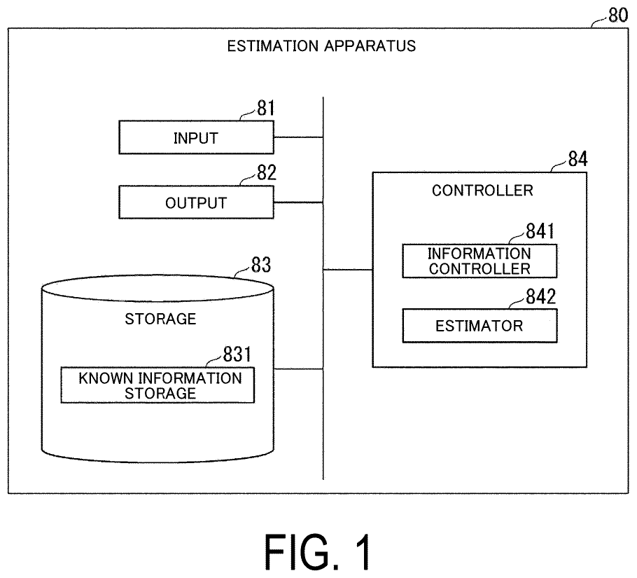

FIG. 1 is a block diagram showing an outline of a functional configuration of an estimation apparatus 80 according to the present invention. The estimation apparatus 80 includes an input 81, an output 82, a storage 83, and a controller 84. The estimation apparatus 80 may be configured by using an information processing apparatus such as a personal computer or a server, or may be configured as a circuit formed on a substrate.

The input 81 receives input of information on the estimation apparatus 80. For example, the input 81 may be configured as a user interface for receiving user's operation. In this case, the input 81 may be configured as an apparatus (input apparatus) for inputting information corresponding to user's action such as a keyboard, a touch panel, a mouse, or a voice input apparatus, for example. The input 81 may be as an interface that communicably connects these input apparatuses to the estimation apparatus 80. The input 81 may be configured as a communication interface for receiving data from other information processing apparatuses. In this case, the input 81 may be configured by using, for example, an apparatus for performing wireless communication or may be configured by using an apparatus for performing wired communication. The input 81 may have a configuration for inputting information outputted from other pieces of hardware or other pieces of software operating in the information processing apparatus on which the estimation apparatus 80 is mounted to the estimation apparatus 80. In this case, the hardware applied to the estimation apparatus 80 may be partially or entirely shared with other pieces of software.

The output 82 outputs the information from the estimation apparatus 80. For example, the output 82 may be configured by an output apparatus for outputting information to a user. In this case, the output 82 may be configured as an output apparatus such as a display, a voice output apparatus, a printer, for example. The output 82 may be an interface communicably connecting these output apparatuses to the estimation apparatus 80. The output 82 may be configured as a communication interface for transmitting data to other information processing apparatuses. In this case, the output 82 may be configured by using, for example, an apparatus for performing wireless communication or may be configured for performing wired communication. The output 82 may have a configuration for outputting the information to other pieces of hardware or other pieces of software operating in the information processing apparatus in which the estimation apparatus 80 is mounted. In this case, the hardware applied to the estimation apparatus 80 may be partially or entirely shared with other pieces of software.

The storage 83 is configured by using a storage apparatus such as a magnetic hard disk apparatus or a semiconductor storage apparatus. The storage 83 functions, for example, as a known information storage 831. The known information storage 831 stores in advance known information used for performing estimation processing by an estimator 842 of the controller 84. For example, the known information storage 831 stores each combination of element code and parameter in association with an SNR (hereinafter referred to as “request SNR”) requested for achieving a certain specific error rate (for example, minus 15 power of 10) in communication using the element code and the parameter. An item corresponding to algorithm to be used is given to the parameter. For example, in an LDPC (Low Density Parity-Check) code, parameters such as the number of repetitions of iterative decode, decimal point accuracy, and decode algorithm are given. For example, in an OFEC (open FEC), parameters such as the number of code word candidates for Chase-II decoding, the decimal point accuracy of a reception value LLR (logarithmic likelihood ratio), and the number of repetitions of iterative decode are given. Such information can be acquired as known information based on an existing research result or the like.

In addition, the known information storage 831 may store the following each value in advance.
Capacity (maximum value of encoding rate) C of each modulation multilevel degree
Binary input-AWGN capacity (SD-FEC capacity) C_S of SD-FEC
Binary input-AWGN capacity (HD-FEC capacity) C_H of HD-FEC
Capacity of various MLC schemes

The value C is expressed by a below Expression 3 using, for example, a bit b and a reception value LLR for capacity transmission in a following BICM scheme.

$$Bit b = ( {b}^{( 1 )} , {b}^{( 2 )} , … , {b}^{( m )} ) , {b}^{( i )} = ( {b}_{1}^{( i )} , {b}_{2}^{( i )} , … , {b}_{n}^{( i )} ) \qquad [ Math . 1 ]$$

$$Reception value LLR l = ( {l}^{( 1 )} , {l}^{( 2 )} , … , {l}^{( m )} ) , {l}^{( i )} = ( {l}_{1}^{( i )} , {l}_{2}^{( i )} , … , {l}_{n}^{( i )} ) \qquad [ Math . 2 ]$$

$$( Expression 3 )$$

$$C = {\sum }_{i = 1}^{m} 𝕀 ( {B}^{( i )} ; Y ) \qquad [ Math . 3 ]$$

Here, an approximate value for mutual information volume is computed by Monte Carlo simulation as expressed by a below Expression 4. Similarly, the capacity of SD-FEC and the capacity of HD-FEC are expressed by Expression 5 and Expression 6, respectively.

$$[ Math . 4 ]$$

$$Mutual information volume 𝕀 ( {B}^{( i )} , Y ) \approx 1 - \frac{1}{n} {\sum }_{j = 1}^{n} {log}_{2} ( 1 + exp ( - ( 1 - 2 {b}_{j}^{( i )} ) {l}_{j}^{( i )} ) ) \qquad ( Expression 4 )$$

$$[ Math . 5 ]$$

$${C}_{S} = 𝕀 ( B ; Y ) \qquad ( Expression 5 )$$

$$[ Math . 6 ]$$

$${C}_{H} = 1 - ℍ ( p ) \qquad ( Expression 6 )$$

Here, p is a bit error rate, and a below Expression 7 is established.

$$[ Math . 7 ]$$

$$ℍ ( p ) := - p {log}_{2} p - ( 1 - p ) {log}_{2} ( 1 \to p ) \qquad ( Expression 7 )$$

In addition, the capacity C_CP of the CP-MLC scheme is expressed as follows.

$$[ Math . 8 ]$$

$${C}_{CP} = \frac{{C}_{bad} + ( d - 1 ) {C}_{good}}{d} \qquad ( Expression 8 )$$

$$[ Math . 9 ]$$

$${C}_{bad} = 𝕀 ( {B}^{( 1 )} ; L ) \approx 1 \frac{1}{n} {\sum }_{j = 1}^{n} {log}_{2} ( 1 + exp ( - ( 1 - 2 {z}_{j}^{( i )} ) {λ}_{j}^{( 1 )} ) ) \qquad ( Expression 9 )$$

$$[ Math . 10 ]$$

$${C}_{good} = 1 - ℍ ( {p}_{CP} ) \qquad ( Expression 10 )$$

p_CP is a bit error-rate related to z\hat{ }(i)_j. L expresses a combination of probability variables of each LLR of d-th lane. When the codes R_H and R_S are used, they are given below.

$$[ Math . 11 ]$$

$${Δ}_{CP} = {C}_{CP} - {R}_{S} \qquad ( Expression 11 )$$

$$[ Math . 12 ]$$

$${Δ}_{H} = {C}_{H} - {R}_{H} \qquad ( Expression 12 )$$

$$[ Math . 13 ]$$

$${Δ}_{S} = {C}_{CP} - {R}_{CP} \qquad ( Expression 13 )$$

λ\hat{ }(1)_j is expressed as a below Expression 15, when a below condition is satisfied.

$$Communication path {P}_{{Y}_{j} \vert {Z}_{j}^{( 1 )}} is independent in each symbol such as y = [ {y}_{1} {y}_{2} … {y}_{n} ] \qquad [ Math . 14 ]$$

$$[ Math . 15 ]$$

$${λ}_{j}^{( 1 )} = log {P}_{{Y}_{j} \vert {Z}_{j}^{( 1 )}} ( {y}_{j} \vert 0 ) / {P}_{{Y}_{j} \vert {Z}_{j}^{( 1 )}} ( {y}_{j} \vert 1 ) + log {P}_{{Z}_{j}^{( 1 )}} ( 0 ) / {P}_{{Z}_{j}^{( 1 )}} ( 1 ) \qquad ( Expression 15 )$$

Here, n′=n/d is satisfied, and n′ is an integer. In addition, y_j is expressed as follows.

$${y}_{j} = [ {y}_{j}^{( 1 )} {y}_{j}^{( 2 )} … {y}_{j}^{( d )} ] \qquad [ Math . 16 ]$$

Further, a numerical Expression shown below is established.

$$[ Math . 17 ]$$

$$\begin{matrix}{P}_{{Y}_{j} \vert {Z}_{j}^{( 1 )}} ( {y}_{i} \vert {z}_{i}^{( 1 )} ) = {\sum }_{{Z}_{j}^{( 2 )} , {Z}_{j}^{( 3 )} , … , {Z}_{j}^{( d )}} {P}_{{Y}_{j} {Z}_{j}^{( 2 )} , {Z}_{j}^{( 3 )} , … {Z}_{j}^{( d )} \vert {Z}_{j}^{( 1 )}} ( {y}_{j} , {z}_{j}^{( 2 )} , {z}_{j}^{( 3 )} , … , {z}_{j}^{( d )} \vert {z}_{j}^{( 1 )} ) \\ = {\sum }_{{Z}_{j}^{( 2 )} , {Z}_{j}^{( 3 )} , … {Z}_{j}^{( d )}} {P}_{{Y}_{j} \vert {Z}_{j}^{( 1 )} , {Z}_{j}^{( 2 )} , … {Z}_{j}^{( d )}} ( {y}_{j} \vert {z}_{j}^{( 1 )} , {z}_{j}^{( 2 )} , {z}_{j}^{( 3 )} , … , {z}_{j}^{( d )} ) {P}_{{Z}_{j}^{( 1 )} , {Z}_{j}^{( 2 )} , … , {Z}_{j}^{( d )}} ( {z}_{j}^{( 2 )} , {z}_{j}^{( 3 )} , … , {z}_{j}^{( d )} ) \\ = {\sum }_{{Z}_{j}^{( 2 )} , {Z}_{j}^{( 3 )} , … , {Z}_{j}^{( d )}} {P}_{{Y}_{j} \vert {X}_{j}^{( 1 )}} ( {y}_{j} \vert {z}_{j}^{( 1 )} ⊕ {z}_{j}^{( 2 )} ⊕ {z}_{j}^{( 3 )} ⊕ … ⊕ {z}_{j}^{( d )} ) {\prod }_{j = 2 , … , d} {P}_{{Y}_{j} \vert {X}_{j}^{( 1 )}} ( {y}_{j} \vert {z}_{j}^{( i )} ) {P}_{{Z}_{j}^{( 1 )}} ( {z}_{j}^{( i )} )\end{matrix}$$

λ\hat{ }(1)_j may be expressed by a below Expression 18.

$$[ Math . 18 ]$$

$${λ}_{j}^{( 1 )} = {l}_{j}^{( 1 )} ⊙ {l}_{j}^{( 2 )} ⊙ … ⊙ {l}_{j}^{( d )} \qquad ( Expression 18 )$$

$${l}_{j}^{( i )} := log \frac{{P}_{Y \vert {X}_{j}^{( i )}} ( y \vert 0 )}{{P}_{Y \vert {X}_{j}^{( i )}} ( y \vert 1 )} + log \frac{{P}_{{X}_{j}^{( i )}} ( 0 )}{{P}_{{X}_{j}^{( i )}} ( 1 )} \qquad [ Math . 19 ]$$

Note that used operator (operator having a point in a circle) is defined as follows.

$$a ⊙ b := 2 tan {h}^{- 1} ( tan h \frac{a}{2} tan h \frac{b}{2} ) ≃ sgn ( a ) sgn ( b ) min ( \vert a \vert , \vert b \vert ) \qquad [ Math . 20 ]$$

$$A function in which when sgn ( a ) := a > 0 is satisfied , + 1 is returned , and when a \leq 0 is satisfied , - 1 is returned \qquad [ Math . 21 ]$$

Next, the controller 84 will be described. The controller 84 is configured by using a processor such as a CPU (Central Processing Unit) and a memory (main memory apparatus). The controller 84 functions as an information controller 841 and an estimator 842 by the processor executing a program. Note that all or some of each function of the controller 84 may be realized by using hardware such as an ASIC (Application Specific Integrated Circuit), a PLD (Programmable Logic Device), or an FPGA (Field Programmable Gate Array). The above-described program may be recorded on a computer-readable recording medium. The computer-readable recording medium is a portable medium, for example, such as a flexible disk, a magneto-optical disk, a ROM, a CD-ROM, or a semiconductor storage apparatus (for example, SSD: Solid State Drive), or a storage apparatus such as a hard disk, a semiconductor storage apparatus, or the like built in a computer system. The above-described program may be transmitted via an electrical communication line.

The information controller 841 inputs information from the input 81. The information controller 841 reads information from the known information storage 831. The information controller 841 outputs the information from the output 82.

The estimator 842 estimates the SNR (request SNR) requested in the MLC (for example, CP-MLC) having a configuration indicated by the inputted information based on the information (information on the MLC configuration) inputted from the input 81 and the information stored in the known information storage 831. For example, the SNR requested in the MLC to which one or a plurality of sets of code and parameter indicated by the inputted information are applied may be estimated. At this time, the estimator 842 estimates the request SNR based on the information stored in the known information storage 831 without performing the simulation using numerical values.

The estimator 842 may obtain the request SNR by, for example, the following processing. First, a difference Δ between rates at the request SNR of the code indicated by inputted information is computed. For example, assuming that the difference in the SD-FEC is defined as Δ_S, the value of Δ_S is given by a below Expression 22.

$$[ Math . 22 ]$$

$${Δ}_{S} = {C}_{S} \cdot ( code rate ) \qquad ( Expression 22 )$$

Similarly, when the difference Δ_H in the HD-FEC is defined as Δ_H, the value of Δ_H is given by a below Expression 23.

$$[ Math . 23 ]$$

$${Δ}_{H} = {C}_{H} \cdot ( code rate ) \qquad ( Expression 23 )$$

The estimator 842 computes the difference Δ between the actual rates by approximating the difference with the value of a below Expression 24.

$$[ Math . 24 ]$$

$$\hat{Δ} = ( ( d - 1 ) {Δ}_{H} + {Δ}_{S} ) / d \qquad ( Expression 24 )$$

The estimator 842 acquires an SNR satisfying below conditions as an estimation value of the request SNR. Note that IR represents information volume, and m represents the number of bits of a symbol per one dimension.

$$[ Math . 25 ]$$

$$( E stimation value of request SNR ) = ( SNR in the case of C [ SNR ] = m Δ + IR ) \qquad ( Expression 25 )$$

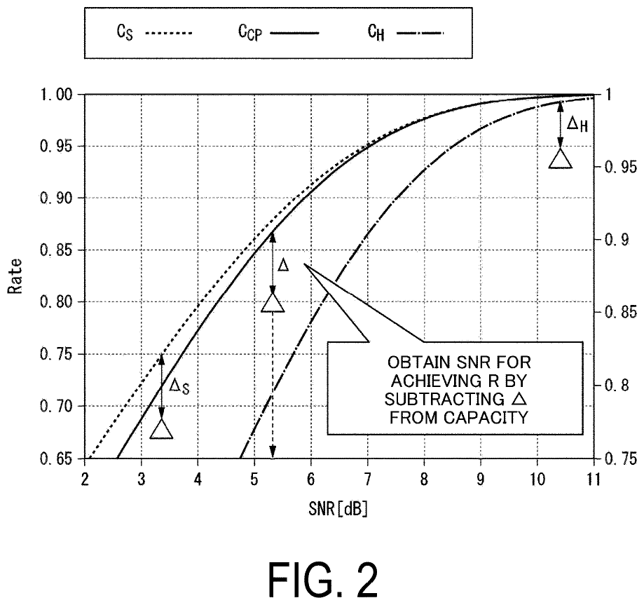

FIG. 2 is a diagram showing an outline of the estimation value of the request SNR. In FIG. 2, a capacity estimation is a premise, when a CP-MLC is used in a BPSK modulation. Triangles related to Δ_S and Δ_H indicate the request SNR of the code indicated by the inputted information, respectively. Δ_S represents a difference between a value indicated by the triangle and a value indicated by C_S in the request SNR. Δ_H represents a difference between a value indicated by the triangle and a value indicated by C_H in the request SNR. A minimum SNR, which is set so that a value obtained by subtracting a value of A obtained based on Δ_S and Δ_H from a graph of C_CP satisfies a predetermined encoding rate condition (for example, 0.80) may be acquired as the estimation value of the request SNR. The value of the encoding rate condition is a different value depending on the MLC scheme or the element code. The estimator 842 may acquire the estimation value of the request SNR for each set of element code and parameter indicated by the inputted information by such processing. The estimator 842 outputs the estimation value of the request SNR via the information controller 841 and the output 82. At this time, the estimator 842 does not simply output the estimation value of the request SNR, but may output the information indicating the set of element code and parameter in association with the estimation value of the request SNR corresponding thereto. A plurality of sets of such pieces of information and estimation values may be outputted.

The estimation apparatus 80 configured in this way can estimate the request SNR related to the MLC corresponding to the inputted information by using the known information (information indicating the relation between the element code and its performance (for example, SNR)) without executing the numerical simulation. Therefore, the performance of encoding can be estimated with the smaller computational complexity.

In the processing of the estimation apparatus 80, it may be applied to, for example, a TL-MLC. In this case, assuming that the bit level is m, a rate difference per bit level is expressed by an expression in which “d” in the Expression 24 is replaced by “m”.

In the estimation apparatus 80, the storage 83 may be provided in another apparatus. For example, the storage 83 may be provided in another information processing apparatus capable of communicating with the estimation apparatus 80. In this case, for example, the information controller 841 may communicate with each other to acquire the information stored in the known information storage 831 of the storage 83.

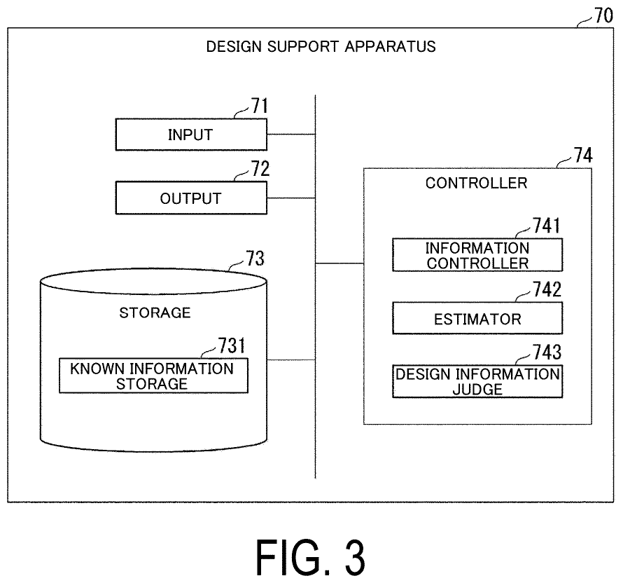

FIG. 3 is a block diagram showing an outline of the functional configuration of the design support apparatus 70 according to the present invention. The design support apparatus 70 includes an input 71, an output 72, a storage 73, and a controller 74. The design support apparatus 70 may be configured by using the information processing apparatus such as a personal computer or a server, or may be configured as the circuit formed on the substrate.

Among the configurations of the design support apparatus 70, the input 71, the output 72, and the storage 73 have the same configuration as the input 81, the output 82, and the storage 83 of the estimation apparatus 80, respectively. The information controller 741 and the estimator 742 in the controller 74 of the design support apparatus 70 have the same configuration as the information controller 841 and the estimator 842 in the controller 84 of the estimation apparatus 80. Hereinafter, a design information judge 743 will be described.

The design information judge 743 selects one or a plurality of sets of element code and parameter corresponding to an application (application region) of a CP-MLC configuration based on information indicating the set of element code and parameter obtained by the estimator 742 and the estimation value of the request SNR corresponding to the information. The design information judge 743 outputs a selection result via the information controller 841 and the output 82.

The design support apparatus 70 configured in this way can easily judge the element code and the parameter suitable for the application of the MLC (for example, CP-MLC) configuration based on the estimation value of the request SNR.

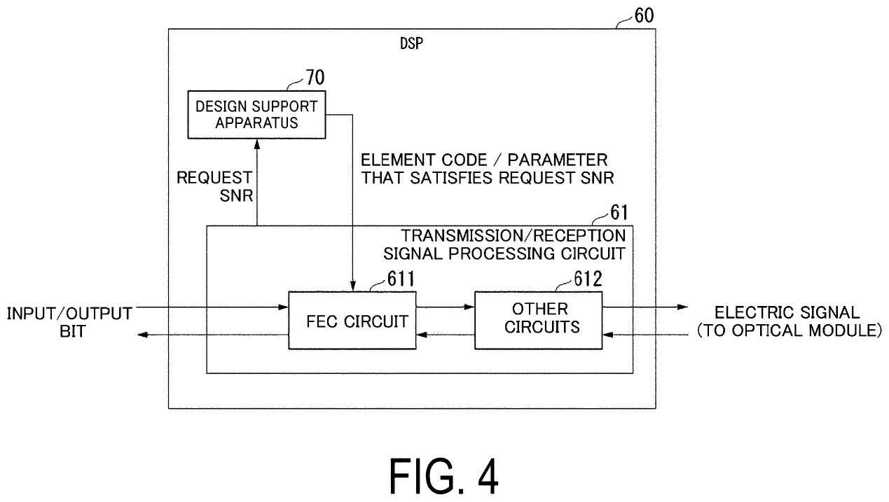

The design support apparatus 70 configured in this way may be incorporated into the DSP. FIG. 4 is a diagram showing a configuration example of the DSP configured in this way. The DSP 60 in FIG. 4 is applied to a transmitter-receiver and is an apparatus using the MLC. The DSP 60 may be, for example, a coherent DSP. The DSP 60 includes a design support apparatus 70 and a transmission/reception signal processing circuit 61. The transmission/reception signal processing circuit 61 includes an FEC circuit 611 and other circuits 612. A specific example of the transmission/reception signal processing circuit 61 is, for example, a BICM (Reference 1).
Reference 1: Caire, Giuseppe, Giorgio Taricco, and Ezio Biglieri. “Bit-interleaved coded modulation.” IEEE transactions on information theory 44.3 (1998): 927-946.

The transmission/reception signal processing circuit 61 requests the appropriate element code and parameter to the design support apparatus 70 in accordance with the state of the transmission line to which the own apparatus is connected. The element code and the parameter judged by the design support apparatus 70 are set in the FEC circuit 611 by the transmission/reception signal processing circuit 61. Such processing is performed at predetermined timing. For example, it may be performed at a period of a predetermined time or at timing when the state of the transmission line changes to a predetermined threshold value or more.

Hereinafter, a specific example of the CP-MLC configuration to which the estimation apparatus 80 or the design support apparatus 70 can be applied will be described.

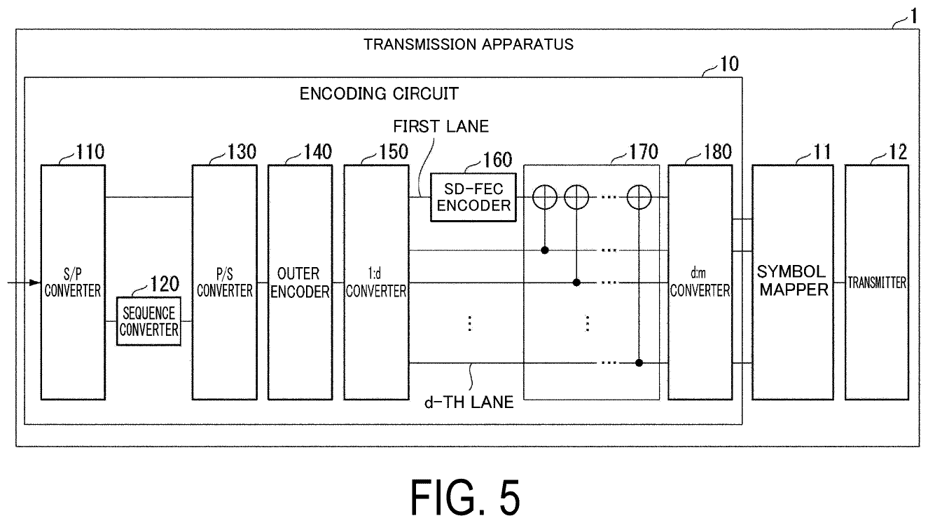

FIG. 5 is a block diagram showing a configuration example of a transmission apparatus 1. The transmission apparatus 1 is a part of a digital coherent communication system, and a transmission apparatus used for the transmission of transmission target data (hereinafter referred to as “transmission data”). The transmission apparatus 1 transmits the transmission data to a reception apparatus connected via a communication path. It is assumed that the communication path is, for example, an AWGN (Additive White Gaussian Noise) communication path.

The transmission apparatus 1 includes an encoding circuit 10, a symbol mapper 11, and a transmitter 12. The encoding circuit 10 is configured by an S/P converter 110, a sequence converter 120, a P/S converter 130, an outer encoder 140, a 1:d converter 150, an SD-FEC encoder 160, a bit conversion circuit 170, and a d:m converter 180.

The S/P converter 110 performs serial-parallel conversion of the inputted transmission target data to divide the transmission target data into a plurality of pieces of data. For example, the S/P converter 110 divides the transmission target data into two pieces of data. The transmission target data is uniform sequence data. Here, the uniform sequence represents an information sequence in which an information sequence (for example, bits) is generated in accordance with a uniform distribution.

The sequence converter 120 converts the uniform sequence into a non-uniform sequence. Specifically, the sequence converter 120 is a converter for reversibly converting the uniform bit sequence having a certain length k (k is an integer of 1 or more) into a non-uniform symbol sequence having a length n (n is an integer of 1 or more). Note that k≤n×(m−1) is satisfied, and redundancy n-k is determined in accordance with a shape of the non-uniform distribution. m is a bit length (bit/symbol) of a symbol. Here, the non-uniform sequence represents an information sequence which is not a uniform sequence. d≥m is satisfied. d represents the number of lanes in the 1:d converter 150.
the P/S converter 130 converts the uniform sequence data outputted from the S/P converter 110 and the non-uniform sequence data converted by the sequence converter 120 into serial data by performing parallel-serial conversion.

The outer encoder 140 simultaneously corrects errors which have not been corrected by the SD-FEC and all the remaining errors. The outer encoder 140 is one aspect of an outer encoder.

The 1:d converter 150 divides the output from the outer encoder 140 into d (d is an integer of 2 or more) lanes, allocates a part of the uniform sequence data to the first lane, and allocates the remaining uniform sequence and amplitude sequence to the second to d-th lane. Note that the 1:d converter 150 may perform interleaving to prevent a burst error caused by an inner code as required.

The SD-FEC encoder 160 performs encoding by an error correction code.

The bit conversion circuit 170 is such a conversion circuit that a ratio in which the input is outputted as it is to the number of bits d per symbol is (d−1)/d or less. By combining with the receiver, errors are concentrated on the bits of the first lane and errors of the bits of the second to d-th lanes are virtually reduced.

The d:m converter 180 converts the sequence data transmitted in each of first to d-th lane into the sequence data of m lanes.

Similarly to the conventional PAS, the symbol mapper 11 allocates bits of the uniform distribution to LSB (Least Significant Bit) equivalent to positive and negative of the symbol, and allocates the non-uniform distribution to MSBs (Most Significant Bits) equivalent to the amplitude to generate the transmission data.

The transmitter 12 transmits the transmission data generated by the symbol mapper 11.

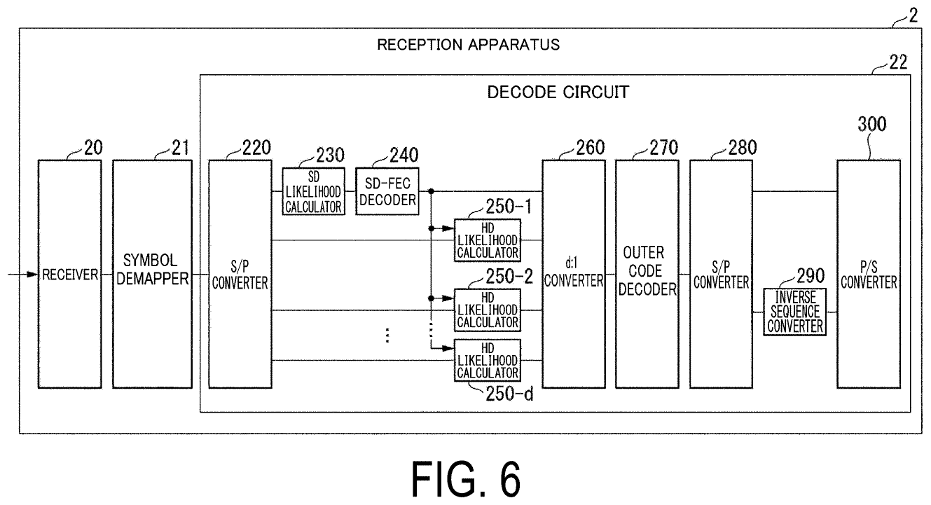

FIG. 6 is a block diagram showing a configuration example of a reception apparatus 2. The reception apparatus 2 is a transmission apparatus used in the digital coherent communication system. The reception apparatus 2 receives the transmission data transmitted from the transmission apparatus 1 connected via the communication path.

The reception apparatus 2 includes a receiver 20, a symbol demapper 21, and a decode circuit 22.

The receiver 20 receives the transmission data transmitted from the transmission apparatus 1 via the communication path.

The symbol demapper 21 demodulates the transmission data received by the receiver 20 by a demodulation scheme corresponding to the modulation scheme.

The decode circuit 22 is configured by an S/P converter 220, an SD likelihood calculator 230, an SD-FEC decoder 240, a plurality of HD likelihood calculators 250-1 to 250-d, a d:1 converter 260, an outer code decoder 270, an S/P converter 280, an inverse sequence converter 290, and a P/S converter 300.

The S/P converter 220 divides the transmission data demodulated by the symbol demapper 21 into a plurality of pieces of data by performing the serial-parallel conversion. For example, the S/P converter 220 divides the transmission data into d pieces which is the number corresponding to the number of lanes.

The SD likelihood calculator 230 computes the likelihood based on the data outputted from the S/P converter 220 and the communication path information. The communication path information represents the distribution of noise of the communication path. The communication path information can be measured by a spectrum analyzer or the like. It is assumed that the communication path information is previously measured and stored in the SD likelihood calculator 230.

The processing of the SD likelihood calculator 230 will be described more specifically. The SD likelihood calculator 230 is a circuit for obtaining a probability likelihood L\hat{ }(1) related to a probability P (y|z\hat{ }(1)) inputted to the SD-FEC decoder 240 in order to estimate the code word z\hat{ }(1) outputted from the SD-FEC encoder 160 from a reception word y and the communication path information P (y|x). For example, when the communication path P (y|z\hat{ }(1)) is independent for each symbol such as y=[y_1, y_2 . . . y_n′], the SD likelihood calculator 230 computes the likelihood L_i\hat{ }(1) based on an Expression 26 described below.

$$[ Math . 26 ]$$

$$\begin{matrix}{L}_{i}^{( 1 )} = log \frac{{P}_{{Z}_{i}^{( 1 )}} ( 0 )}{{P}_{{Z}_{i}^{( 1 )}} ( 1 )} + log \frac{{P}_{{Y}_{i} \vert {Z}_{i}^{( 1 )}} ( {y}_{i} \vert 0 )}{{P}_{{Y}_{i} \vert {Z}_{i}^{( 1 )}} ( {y}_{i} \vert 1 )} \\ \begin{matrix}{P}_{{Y}_{i} \vert {Z}_{i}^{( 1 )}} ( {y}_{i} \vert {z}_{i}^{( 1 )} ) = {\sum }_{{Z}_{i}^{( j )} : j = 2 , 3 , … , d} {P}_{{Y}_{i} , {Z}_{i}^{( 2 )} , {Z}_{i}^{( 3 )} , … , {Z}_{i}^{( d )} \vert {Z}_{i}^{( 1 )}} ( {Y}_{i} , {z}_{i}^{( 2 )} , {z}_{i}^{( 3 )} , … , {z}_{t}^{( d )} \vert {z}_{i}^{( 1 )} ) ) \\ = {\sum }_{{Z}_{i}^{( j )} : j = 2 , 3 , … , d} {P}_{{Y}_{i} , {Z}_{i}^{( 1 )} , {Z}_{i}^{( 2 )} , {Z}_{i}^{( 3 )} , … , {Z}_{i}^{( d )}} ( {Y}_{i} \vert {z}_{i}^{( 1 )} , {z}_{i}^{( 2 )} , {z}_{i}^{( 3 )} , … , {z}_{i}^{( d )} ) {P}_{{Z}_{i}^{( 2 )} , {Z}_{i}^{( 3 )} , … , {Z}_{i}^{( d )}} ( {Z}_{i}^{( 2 )} , {Z}_{i}^{( 3 )} , … , {Z}_{i}^{( d )} ) \\ = {\sum }_{{Z}_{j}^{( 2 )} , {Z}_{j}^{( 3 )} , … , {Z}_{j}^{( d )}} {P}_{{Y}_{j} \vert {X}_{j}^{( 1 )}} ( {Y}_{i} \vert {z}_{i}^{( 1 )} ⊕ {z}_{i}^{( 2 )} ⊕ {z}_{i}^{( 3 )} ⊕ … ⊕ {z}_{j}^{( d )} ) {\prod }_{{Z}_{i}^{( j )} j = 2 , 3 , … , d} {P}_{{Y}_{i} \vert {X}_{i}^{( 1 )}} ( {Y}_{i} \vert {z}_{i}^{( j )} ) {P}_{{X}_{i}^{( j )}} ( {z}_{i}^{( j )} )\end{matrix}\end{matrix} \qquad ( 26 )$$

Here, n′=n/d is satisfied, and an integer. Here, it is assumed that the code length and the number of divisions are designed so that n′ becomes an integer. Further, y_i=[y_i\hat{ }(1) y_i\hat{ }(2) . . . y_i\hat{ }(d)] is satisfied.

The SD-FEC decoder 240 performs error correction decode by using the likelihood L_i\hat{ }(1) computed by the SD likelihood calculator 230, and acquires a code word z\hat{ }(1) in which the error is corrected.

A plurality of HD likelihood calculators 250-1 to 250-d calculates the likelihood related to conditional probability P (y, z\hat{ }(1)|z\hat{ }(s)) based on the corrected code word z\hat{ }(1), the reception word y, and the communication path information P (y|x). For example, similarly to the SD likelihood calculator 230, in the case where the communication path P (y|z\hat{ }(1)) is independent for each suffix such as y=[y_1y_2 . . . y_n′], each HD likelihood calculator 250 performs a hard judgement based on an Expression 27 described below to calculate a bit z\hat{ }(s). Note that s is an integer of 2 or more and d or less.

$$[ Math . 27 ]$$

$$\begin{matrix}{L}_{i}^{( s )} = log \frac{{P}_{{Z}_{i}^{( s )}} ( 0 )}{{P}_{{Z}_{i}^{( s )}} ( 1 )} + log \frac{{P}_{{Y}_{i} , {Z}_{i}^{( 1 )} \vert {Z}_{i}^{( s )}} ( {y}_{i} , {Z}_{i}^{( 1 )} \vert 0 )}{{P}_{{Y}_{i} , {Z}_{i}^{( 1 )} \vert {Z}_{i}^{( s )}} ( {y}_{i} , {Z}_{i}^{( 1 )} \vert 1 )} \\ Note that {z}_{i}^{( s )} = \{ \begin{matrix}0 & ( {L}_{i}^{( s )} \geq 0 ) \\ 1 & ( {L}_{i}^{( s )} < 0 )\end{matrix} \\ \begin{matrix}{P}_{{Y}_{i} , {Z}_{i}^{( 1 )} \vert {Z}_{i}^{( s )}} ( {y}_{i} , {z}_{i}^{( 1 )} \vert {z}_{i}^{( s )} ) = {\sum }_{{Z}_{i}^{( j )} : j = 2 , 3 , … , s - 1 , s + s , … , d} {P}_{{Y}_{i} , {Z}_{i}^{( 1 )} , {Z}_{i}^{( 2 )} , … , {Z}_{i}^{( s - 1 )} {Z}_{i}^{( s - 3 )} , … , {Z}_{i}^{( d )} \vert {Z}_{i}^{( s )}} ( {Y}_{i} , {z}_{i}^{( 1 )} , {z}_{i}^{( 2 )} , … , {z}_{i}^{( s - 1 )} , {z}_{i}^{( s + 1 )} , … , {z}_{t}^{( d )} \vert {z}_{i}^{( s )} ) \\ = {\sum }_{{Z}_{i}^{( j )} : j = 2 , 3 , … , s - 1 , s + 1 , … , d} {P}_{{Y}_{i} \vert {Z}_{i}^{( 1 )} , {Z}_{i}^{( 2 )} , … , {Z}_{i}^{( d )}} ( {Y}_{i} \vert {z}_{i}^{( 1 )} , {z}_{i}^{( 2 )} , … , {z}_{i}^{( d )} ) {P}_{{Z}_{i}^{( 1 )} , {Z}_{i}^{( 2 )} , … , {Z}_{i}^{( s - 3 )} {Z}_{i}^{( s + 1 )} , … , {Z}_{i}^{( d )}} ( {z}_{i}^{( 1 )} , {z}_{i}^{( 2 )} , … , {z}_{i}^{( d ) ,} ) \\ = {\sum }_{{Z}_{i}^{( f )} : j = 2 , 3 , … , s - 1 , s + 1 , … d} {P}_{{Y}_{i} \vert {X}_{i}^{( 1 )}} ( {Y}_{i} \vert {z}_{i}^{( 1 )} ⊕ {z}_{i}^{( 2 )} ⊕ {z}_{i}^{( 3 )} ⊕ … ⊕ {z}_{j}^{( d )} ) {\prod }_{{Z}_{i}^{( j )} j = 2 , 3 , … , s + 1 , s + 1 , … , d} {P}_{{Y}_{i} \vert {X}_{i}^{( 1 )}} ( {Y}_{i} \vert {z}_{i}^{( j )} ) {P}_{{Z}_{i}^{( j )}} ( {z}_{i}^{( j )} )\end{matrix}\end{matrix} \qquad ( 27 )$$

The d:1 converter 260 combines the information bit sequence corresponding to the code word z⁽¹⁾ transmitted in the first lane and each z\hat{ }(s) into one.

The outer code decoder 270 decodes the outer code after converting the bit sequence.

The S/P converter 280 divides the inputted data into a plurality of pieces of data by performing the serial-parallel conversion. For example, the S/P converter 280 divides the data into two pieces of data. The S/P converter 280 outputs the non-uniform sequence data to the inverse sequence converter 290, and outputs the uniform sequence data to the P/S converter 300.

The inverse sequence converter 290 converts the non-uniform sequence into the uniform sequence. Specifically, the inverse sequence converter 290 is a converter for reversibly converting the non-uniform symbol sequence having a length n into the uniform bit sequence having a length k. Thus, the original uniform sequence is restored.

The P/S converter 300 converts the uniform sequence data outputted from the S/P converter 280 and the uniform sequence data converted by the inverse sequence converter 290 into serial data by performing the parallel-serial conversion. Thus, the transmission data can be decoded.

Although the embodiment of the present invention has been described in detail with reference to the drawings above, a specific configuration is not limited to this embodiment and design within the scope of the gist of the present invention, and the like are included.

### INDUSTRIAL APPLICABILITY

The present invention can be applied to a communication system design using the encoder and the decoder.

### REFERENCE SIGNS LIST

1 Transmission apparatus
2 Reception apparatus
10 Encoding circuit
20 Receiver
21 Symbol demapper
22 Decode circuit
70 Design support apparatus
71 Input
72 Output
73 Storage
731 Known information storage
74 Controller
741 Information controller
742 Estimator
743 Design information judge
80 Estimation apparatus
81 Input
82 Output
83 Storage
831 Known information storage
84 Controller
841 Information controller
842 Estimator

1. An estimation apparatus comprising:
a processor; and
a storage medium having computer program instructions stored thereon, when executed by the processor, perform to:
read information from the storage that stores a set of code and parameter used for communication and information indicating performance requested to achieve predetermined communication quality in communication using the code and parameter in association with each other, and estimate an SNR to be requested in an MLC (Multilevel Coding) using the code and parameter indicated by the inputted information.

2. The estimation apparatus according to claim 1,
wherein the computer program instructions further judge
one or a plurality of sets of code and parameter to be applied to the MLC based on the information estimated.

3. An estimation method comprising:
reading information from a storage that stores a set of code and parameter used for communication and information indicating performance requested to achieve predetermined communication quality in communication using the code and parameter in association with each other; and estimating an SNR to be requested in an MLC (Multilevel Coding) using the code and parameter indicated by the inputted information.

4. The estimation method according to claim 3, the estimation method further comprising:
judging one or a plurality of sets of code and parameter to be applied to the MLC based on the information.

5. A non-transitory computer-readable recording medium storing a computer program causing a computer to perform:
reading information from a storage that stores a set of code and parameter used for communication and information indicating performance requested to achieve predetermined communication quality in communication using the code and parameter in association with each other;
and estimating an SNR to be requested in a MLC (Multilevel Coding) using the code and parameter indicated by the inputted information.

6. The non-transitory computer-readable recording medium according to claim 5,
wherein the program causes the computer to further perform:
judging one or a plurality of sets of code and parameter to be applied to the MLC based on the information estimated.
